(19) United States
(12) Patent Application Publication
(10) Pub. No.: US 2004/0179109 A1
(43) Pub. Date: Sep. 16, 2004

(54) Image pickup apparatus with a reduced time lag of shutter release

(75) Inventor: Kazuyuki Kurosawa, Iruma-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/630,482

(22) Filed: Jul. 29, 2003

(30) Foreign Application Priority Data
Aug. 6, 2002 (JP) 2002-228455

(51) Int. Cl. H04N 5/225

(52) U.S. Cl. 348/222.1

(57) ABSTRACT

An image pickup apparatus comprising a CCD (12), responsive to a periodically occurring driving timing signal, for picking up an image of an object, a shutter key (23) for producing an operation signal when depressed, a main CPU (20) for controlling the whole image pickup operation of the image pickup apparatus, for directly receiving the operation signal produced by operating the shutter key (23), and for sensing as an interrupt signal an initial change in the operation signal to thereby give an instruction to cause the image pickup element to start to pick up the image of the object, and an image processing engine (13), responsive to the instruction given by the main CPU (20), for immediately producing a drive timing signal to cause the CCD (12) to start to pick up the image of the object without waiting for an occurrence of a periodically occurring drive timing signal, and for processing data on the image of the object picked up by the CCD (12).

### BACKGROUND OF THE INVENTION

1. Field of the Invention

The present invention relates to image pickup apparatus and method usable for picking up an image of an object moving rapidly.

2. Background Art

FIGS. 3A and 3B illustrate an image pickup process corresponding to operation of a shutter key of a digital still camera as one kind of general image pickup apparatus.

FIG. 3A illustrates a relationship in circuit configuration between the shutter key 1 which includes a normally open key switch, a sub CPU 2 that processes operation signals produced by operating various key switches including the shutter key 1, and a main CPU 3 that controls the whole camera operation.

The shutter key 1 is supplied at one end with a voltage V and grounded at the other end via a resister R and also connected at the other end to the sub CPU 2.

The sub CPU 2 samples an operation signal produced by operating each of all the keys including the shutter key 1. When the sub CPU 2 senses based upon the sampled signal that the shutter key has been operated, it communicates to the main CPU 3 that the shutter key 1 was operated.

Receiving this information, the main CPU 3 causes a CCD (not shown) as an image pickup element to pick up an image of an object and records resulting image data on a recording medium (not shown).

FIG. 3B illustrates timing of the respective processes performed by the apparatus components of FIG. 3A. FIG. 3B-(1) illustrates operation of the shutter key 1 in which it is assumed that the shutter key 1 was depressed for a given time for image pickup purposes after it had been released. As shown in FIG. 3B-(2), at that time it is assumed that some chattering occurs in rising and falling portions of a pulse waveform of the operation signal at the point A inputted to the sub CPU 2.

As shown in FIG. 3B-(3), the sub CPU 2 samples the waveform of the operation signal produced by operating the shutter key 1 at predetermined intervals of time, for example, of 10-milliseconds. As shown in FIG. 3B-(4), in order to eliminate the chattering components, the sub CPU 2 should determine that the shutter key 1 was depressed when an on state of the pulse waveform of the operation signal inputted to the sub CPU 2 was sampled successively three times and then the shutter key 1 was released when an off state of the pulse waveform was sampled successively three times.

As shown in FIG. 3B-(5), the sub CPU 2 communicates these determinations to the main CPU 3 when these determinations were made respectively.

After receiving the communication from the sub CPU 2 that the shutter key was depressed, the main CPU 3 selects an image pickup mode to drive the CCD to thereby pick up an image of an object, as shown in FIG. 3B-(6). At this time, approximately 60 milliseconds have elapsed since the shutter key 1 was first depressed, as shown.

When a rate of displaying images picked up by the CCD as through images on a liquid crystal monitoring display (not shown) in a so-called high speed draft mode is, for example, 30 images per second, the CCD is driven in a cycle of approximately 33 milliseconds, as shown in a pattern of a vertical sync pulse VD applied in FIG. 3B-(7).

Therefore, as shown in FIG. 3B-(8), the CCD switches from a high-speed draft mode to an exposure mode in which an actual exposure operation is performed, with a time delay of 0-33 milliseconds after the main CPU 3 was switched to the image pickup mode.

As a result, a maximum time lag of approximately 100 milliseconds occurs until the exposure begins actually after the shutter key 1 was depressed.

### SUMMARY OF THE INVENTION

According to one aspect of the present invention, there is provided an image pickup apparatus comprising: an image pickup element, responsive to a periodically occurring drive timing signal, for picking up an image of an object; a shutter key for producing an operation signal when depressed; a main control unit for controlling the whole image pickup operation of the image pickup apparatus, for directly receiving the operation signal produced by operating the shutter key, and for sensing as an interrupt signal an initial change in the operation signal to thereby to give an instruction to cause the image pickup element to start to pick up the image of the object; and an image processor, responsive to the instruction given by the main control unit, for immediately producing a drive timing signal to cause the image pickup element to start to pick up the image of the object without waiting for an occurrence of a periodically occurring drive timing signal, and for processing data on the image of the object picked up by the image pickup element.

According to another aspect of the present invention, there is also provided an image pickup apparatus comprising: an image pickup element for picking up an image of an object; a shutter key for producing an operation signal when depressed; a main control unit for controlling the whole image pickup operation of the image pickup apparatus, for directly receiving the operation signal produced by operating the shutter key, and for sensing an on state of the operation signal to thereby give an instruction to cause the image pickup element to start to pick up the image of the object; and a sub control unit for receiving a second operation signal produced by depressing a key switch, for sensing an on state of the second operation signal, and for delivering information on the sensed on state of the second operation signal to the main control unit.

According to still another aspect of the present invention, there is also provided an image pickup apparatus comprising an image pickup element for picking up an image of an object; a shutter key for producing an operation signal when depressed; and a main control for directly receiving the operation signal produced by operating the shutter key, for sensing as an interrupt signal an initial change in the operation signal to thereby give an instruction to cause the image pickup element to start to pick up the image of the object, and for determining that the shutter key is released when an off state of the operation signal was sensed successively a predetermined number of times by sampling the operation signal at predetermined intervals of time.

According to a further aspect of the present invention, there is also provided an image pickup apparatus comprising: an image pickup element for picking up an image of an object; a shutter key for producing an operation signal when depressed; a main control unit for directly receiving the operation signal produced by operating the shutter key, for once sensing an on state of the operation signal by sampling the operation signal at predetermined intervals of time to thereby give an instruction to cause the image pickup element to start to pick up the image of the object, and for determining that the shutter key is released when an off state of the operation signal was sensed successively a predetermined number of times by sampling the operation signal at predetermined intervals of time.

According to a still further aspect of the present invention, there is also provided an image pickup method comprising the steps of controlling the whole image pickup operation, directly receiving an operation signal produced by depression of a shutter key, and sensing as an interrupt signal an initial change in the operation signal to thereby give an instruction to cause the image pickup element to start to pick up an image of an object; and responsive to the instruction, immediately producing a drive timing signal to cause the image pickup element to start to pick up the image of the object without waiting for an occurrence of a periodically occurring drive timing signal, and processing data on the image of the object picked up by the image pickup element.

According to another aspect of the present invention, there is also provided an image pickup method comprising: a main control step including controlling the whole image pickup operation, directly receiving an operation signal produced by depression of a shutter key, and sensing an on state of the operation signal to thereby instruct an image pickup element to start to pick up an image of an object; and a sub control step including receiving a second operation signal produced by depression of a key switch, sensing an on state of the second operation signal, and delivering information on the sensed on state of the second operation signal to the main control step.

According to still another aspect of the present invention, there is also provided an image pickup method comprising the steps of directly receiving an operation signal produced by depression of a shutter key, sensing as an interrupt signal an initial change in the operation signal to thereby instruct an image pickup element to pick up an image of an object; and determining that the shutter key is released when an off state of the operation signal was sensed successively a predetermined number of times by sampling the operation signal at predetermined intervals of time.

According to a futher aspect of the present invention, there is also provided an n image pickup method comprising the steps of directly receiving an operation signal produced by depression of a shutter key, sensing an on state of the operation signal by sampling the operation signal at predetermined intervals of time, and then instructing an image pickup element to start to pick up an image of an object when the on state of the operation signal was sensed once; and determining that the shutter key is released when an off state of the operation signal was sensed successively a predetermined number of times by sampling the operation signal at predetermined intervals of time.

### BFIEF DESCRIPTION OF THE DRAWINGS

FIG. 1 is a block diagram of a circuit configuration of a digital still camera as one embodiment of the present invention;

FIG. 2 illustrates an image pickup process of the digital camera corresponding to operation of its shutter key; and

FIG. 3 illustrates an image pickup process corresponding to operation of a shutter key of a prior-art general digital still camera.

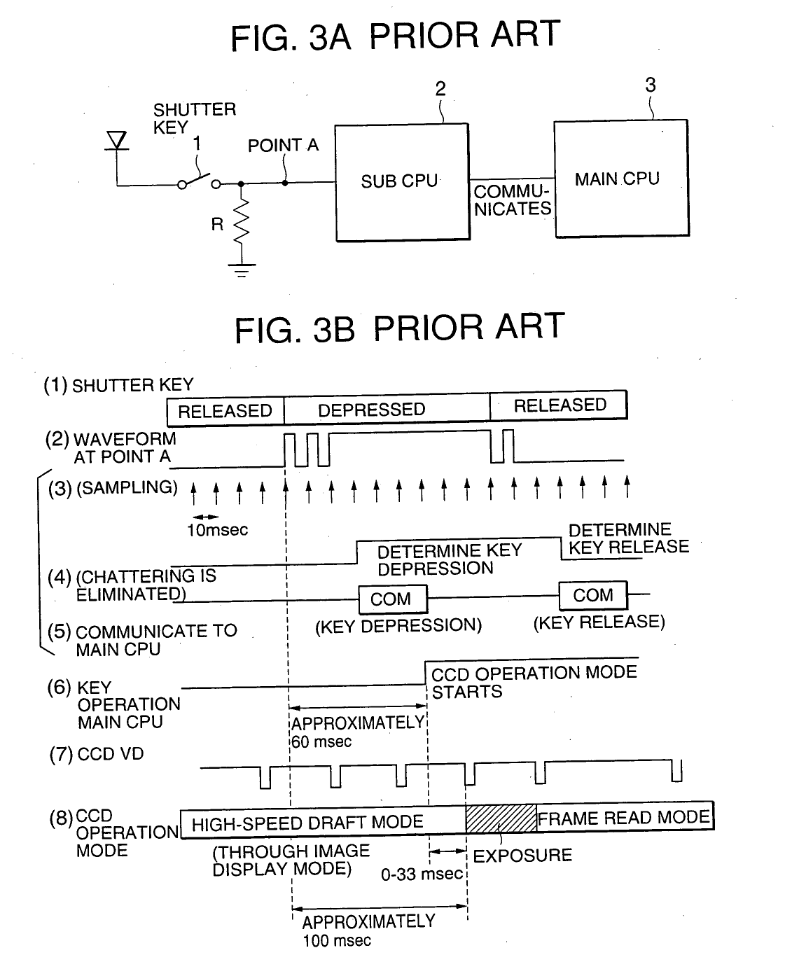

### DESCRIPTION OF THE PREFERRED EMBODIMENTS

One embodiment of the present invention applied to a digital still camera (hereinafter referred to as “digital camera”) will be described with reference to the accompanying drawings.

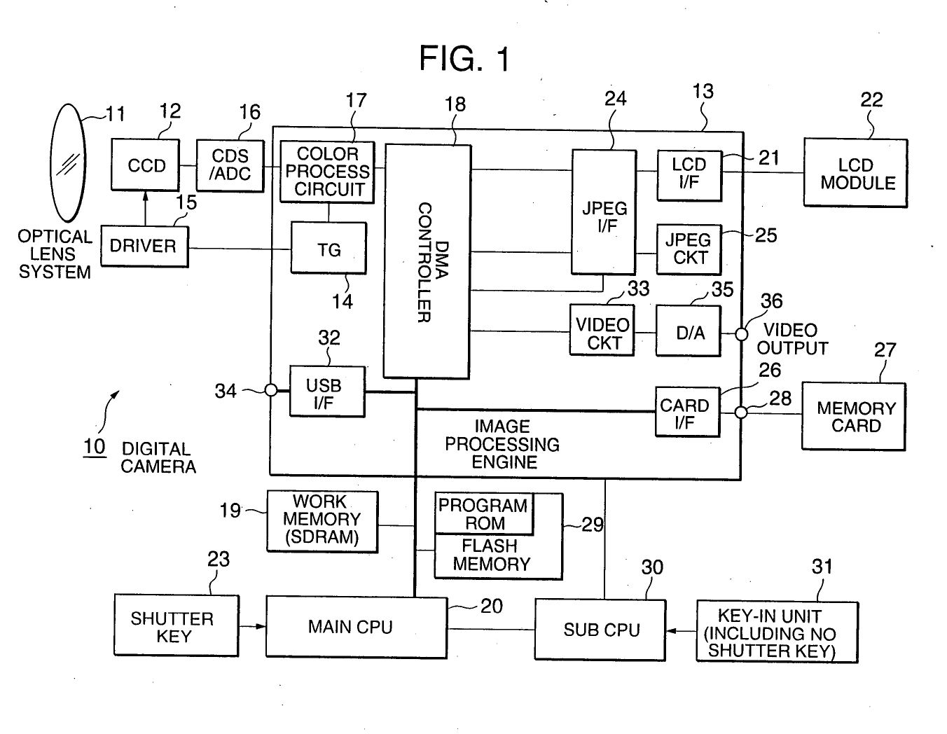

FIG. 1 shows the circuit configuration of the digital camera, generally denoted by reference numeral 10. The digital camera 10 is settable selectively to one of image pickup and play modes as basic modes. In the image pickup mode, a CCD 12 as an image pickup element, disposed after an optical lens system 11 on an optical axis, is scanned by a timing generator (TG) 14 of an image processing engine 13 and a driver 15 to thereby produce, for monitoring purposes, a photoelectric conversion output corresponding to a focused optical image for one picture at predetermined cycles.

The photoelectric conversion output includes three analog primary color (red (R), green (G) and blue (B)) component signals, each of which is appropriately adjusted in gain, sampled, held and converted by a sample and A/D converter (CDS/ADC) 16 to digital data, which is then outputted to a color process circuit 17 of the image-processing engine 13.

The color process circuit 17 performs a color process including a pixel interpolation process and a γ-correction process on the digital image data received from the sample and A/D converter 16 to thereby produce a digital brightness signal Y and digital color difference signals Cb and Cr, which are then delivered to a DMA (Direct Memory Access) controller 18.

The DMA controller 18 temporarily writes the brightness signal Y and the color difference signals Cb and Cr from the color process circuit 17 to an internal buffer memory (not shown) thereof, using a complex sync signal, a memory write enable signal and a clock signal which are also received from the color process circuit 17, and then DMA transfers the written signals to a work memory 19 as a buffer memory, composed, for example, of a SDRAM provided outside the image-processing engine 13.

The main CPU 20 is connected to the image-processing engine 13 to control the whole operation of the digital camera 10. After DMA transferring the brightness and color difference signals to the work memory 19, the main CPU 20 reads out the brightness and color difference signals from the work memory 19, converts these signals to a video signal via an LCD interface (I/F) 21 of the image-processing engine 13, and then delivers the video signal to an LCD module 22.

The LCD module 22 includes, for example, a color liquid crystal display panel with backlight and its driver (not shown). The LCD module 22 is disposed on a back of the digital camera 10 and functions as a monitor display unit (electronic finder) in the image pickup mode. The LCD module 22 displays via the LCD interface 21 an image picked up by the CCD 12.

When the shutter key 23 is depressed at a desired timing of picking up a still image of an object in a state in which an image of the object is displayed in real time as a monitor image on the LCD module 22, a corresponding operation signal is produced.

In response to the operation signal produced by depressing the shutter key 23, the main CPU 20 resets the image pickup operation of (or disables a periodic drive timing signal for) the CCD at that time and then performs a record storing process.

In this record storing process, the main CPU 20 reads from the work memory 19 each of the brightness and color different signals Y, Cb and Cr for one frame to be stored in the work memory 19 in units of a basic block of 8 pixels (vertical)×8 pixels (horizontal) for a respective one of the brightness and color different signals, and writes these signals to a JPEG (Joint Photograph coding Experts Group) circuit 25 via the DMA controller 18, and a JPEG interface (I/F) 24 of the image-processing engine 13. The JPEG circuit 25 performs an ADCT (Adaptive Discrete Cosine Transform) operation on the written signals and compresses the resulting data, using Huffman encoding process as an entropy encoding system.

The main CPU 20 then writes the data file in the form of a one-image data file via a card interface (I/F) 26 of the image-processing engine 13 to a memory card 27, which has enclosed a non-volatile flash memory therein, attached removably as a recording medium for the digital camera 10. Reference numeral 28 denotes a connector by which the memory card 27 is attached or removed.

When the main CPU 20 completes writing the whole compressed data in the form of a one-image data file to the memory card 27, the main CPU 20 returns to the mode for displaying the monitor image on the LCD module 22.

The main CPU 20 is further connected to a flash memory 29 and the sub CPU 30 in addition to the image-processing engine 13 and the work memory 19.

The flash memory 29 is an EEPROM in which its content is rewritable in units of a block. A part of the EEPROM is used as a protected program ROM that has stored an operating program for the main CPU 20 while the remainder of the EEPROM is used as a built-in memory that records data on a picked-up image like the memory card 27.

The sub CPU 30 samples an operation signal produced by operating each of keys of the key-in unit 31 excluding the shutter key 23 and communicates a corresponding sampled signal representing the content of the key operation to the main CPU 20 and the image-processing engine 13.

In the image-processing engine 13, an USB (Universal Serial Bus) interface (I/F) 32 and a video circuit 33 are connected to the DMA controller 18.

The USB interface 32 is made in accordance with USB standards. The USB interface 32 provides input/output control in order that image data is received externally via an USB terminal 34 and recorded on the memory card 27 or flash memory 29, and that image data stored on the memory card 27 or flash memory 29 is read and output via the USB terminal 34 to the outside.

The video circuit 33 converts image data read out from the memory card 27 or flash memory 29 in the play mode to a digital video signal and delivers this video signal to a D/A converter 35.

The D/A converter 35 converts the digital video signal received from the video circuit 33 to an analog signal, which is then delivered to an outside device connected to the video terminal 36.

As described above, the key-in unit 31 includes the keys excluding the shutter key 23. The key-in unit 31 includes a mode select key that selects one of an image pickup mode and a play mode as basic modes; a menu key that displays various items of the menu; a cross key that indicates one of up, down, right and left directions to thereby select one of image/modes other than the two basic modes and specify one of the indicated menu items, a set key positioned at the center of the cross key to indicate what is selected by the cross key at that time; and a display key that turns on/off the display of the LCD module 22 (These keys are not shown).

Operation of the inventive digital camera will be described next.

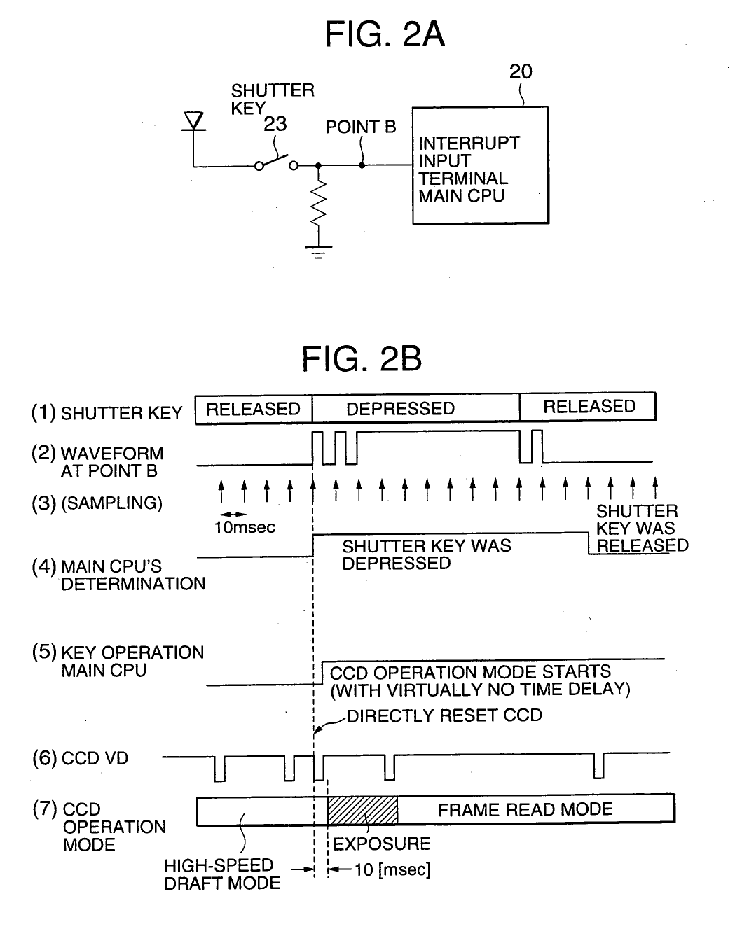

FIG. 2A shows a relationship in circuit configuration between the shutter key 23 that includes a normally open key switch and the main CPU 20 that receives an operation signal produced by operating the shutter key 23 as an interrupt signal from an interrupt input terminal (point B).

The shutter key 23 is supplied at one end with a voltage V and grounded at the other end via a resister R and also connected at the other end to the interrupt input terminal (point B) of the main CPU 20.

Directly receiving the operation signal produced by depressing the shutter key 23, the main CPU 20 immediately starts an interrupt process in which the CCD 12 as the image pickup element is driven to pick up an image of a target object, a predetermined process is performed on the obtained image data in the image-processing engine 13, and then resulting data is recorded on the memory card 27.

FIG. 2B illustrates the timing of operation of relevant elements of the circuit of FIG. 2A.

FIG. 2B-(1) shows an operative state of the shutter key 23 where the shutter key 23 was first released and then depressed for a predetermined time for image pickup purposes. At this time, as shown in FIG. 2B-(2) it is assumed that a pulse waveform of the operation signal at the point B through which it was inputted to the main CPU 20 chatters for some extent in each of its rising/falling portions.

The main CPU 20 immediately determines based upon a first rising edge of the waveform as an interrupt signal as shown in FIG. 2B-(4) that the shutter key 23 was depressed, and immediately applies a vertical sync pulse VD to the CCD 12 to thereby directly reset the CCD 12, as shown in FIG. 2B-(6). Subsequently, as shown in FIG. 2B-(5), the main CPU 20 causes the CCD 12 to perform an image pickup operation, and prevents the sub CPU 30 from responding to operation of another key of the key-in unit 31. At this time, a time lag hardly occurs after the shutter key 23 was depressed first, as shown.

Then, at the timing of an end, or more specifically a rise, of the vertical sync pulse VD applied to the CCD 12, as shown in FIG. 2B-(6), the operative mode of the CCD 12 shifts directly from the monitor display high-speed draft mode present so far to the exposure mode to start an actual exposure operation.

A time lag present from the time when the shutter key 23 was depressed to the time when the exposure actually starts is equal to substantially the width of the vertical sync pulse VD, or approximately 10 milliseconds, as shown in FIG. 2B-(7).

After the exposure, the CCD 12 shifts to a frame read mode in which the CCD 12 reads electric charges for one frame stored as shown in FIG. 2B-(7) in accordance with the vertical sync pulse VD of FIG. 2B-(6).

It is assumed that as shown in FIG. 2B-(1) the depression of the shutter key 23 is released and the voltage waveform at the point B chatters to some extent, as shown in FIG. 2B-(2).

In that case, the main CPU 20 recognizes a release of the shutter key 23 from its depression based upon the sampled voltage waveform of the operation signal produced by the key, as shown in FIG. 2B-(3), and does not determine that the shutter key 23 has been released until the main CPU 20 has sensed an off state of the voltage waveform of the operation signal successively a plurality of times, for example three times, to eliminate the chattering, as shown in FIG. 2B-(4).

As described above, the operation signal produced by operating the shutter key 23 should be inputted directly to the main CPU 20 without going through the sub CPU 30. In addition, the depression of the shutter key 23 is directly determined by use of the interrupt signal including the first rising edge of the key operation signal that includes chattering portions.

Therefore, the main CPU 20 can handle detection of the depression of the shutter key 23 preferentially to thereby shift its operation to the image pickup operation in real time with virtually no time lag.

In that case, at the initial depression of the shutter key 23 the operation signal produced by depressing the shutter key 23 chatters. The CPU 20 ignores the chattering state of the operation signal, senses a first change in the waveform of the operation signal and immediately shifts to the image pickup operation. The chattering is then settled in a short time to thereby provide a stabilized on-state operation signal necessarily. Thus, there are no problems.

The main CPU 20 determines whether or not the shutter key 23 was released from its depression after eliminating the chattering components of the operation signal by the sampling operation.

Thus, when it is tried to determine the release of the shutter key 23 from its depression by sampling the operation signal including the chattering portions or by usig the key interrupt signal, there is a possibility that when a head of the waveform of an operation signal produced by depressing the shutter key 23 chatters, an off state of the operation signal following its on state in the head chattering waveform is sensed to thereby determine erroneously that the shutter key 23 was released from its depression. This erroneous determination, however, is prevented advantageously. In addition, an influence of the chattering portions of the operation signal on the determination about whether or not the shutter key was depressed is eliminated and the operative state of the shutter key 23 is determined correctly. The determination of the depression and its release of the shutter key 23 is simplified compared to the case where they are determined by sampling the operation signal including the chattering portions or by using the key interrupt signal. The determination of release of the shutter key 23 is not affectted adversely because it need not be made promptly.

In addition, since the operation signal produced by operating the shutter key 23 is directly inputted to the main CPU 20 without going through the sub CPU 30, the time lag is virtually eliminated without producing any demerits excluding that the main CPU 20 requires the interrupt signal input terminal.

Furthermore, receiving an instruction from the main CPU 20, the image-processing engine 13 immediately resets the CCD 12 which has been so far in its monitoring state and shifts the CCD 2 to its exposure operation.

Thus, the time lag present possibly between the depression of the shutter key and the beginning of the actual exposure operation is reduced to a negligible constant value, for example, of approximately 10 milliseconds in the example of FIG. 2.

The sub CPU 30 senses operation of the respective key switches of the key-in unit 31 excluding the shutter key 23 and having corresponding small time lags that do not influence the operability of the digital camera, by sampling the respective operation signals produced by operating the keys, delivers signals representing the sensed key operations to the main CPU 20 to thereby cause the main CPU 20 to provide required operation control. Thus, the load on the main CPU 20 is reduced.

While in the embodiment depression of the shutter key 23 was illustrated as determined by using as an interrupt signal a first on state of the operation signal including the initial chattering portions produced by depression of the shutter key without using the sampled operation signal, sensing by once sampling the on state of the operation signal including chattering portions may be determined as indicating depression of the shutter key. In this case, although a time lag of a maximum of 10 milliseconds (sample period) occurs compared to the present embodiment, this system provides large advantage over the prior art.

The present invention is not limited to the above embodiment. Many changes and modifications are possible without departing from the spirit and scope of the invention defined in the attached claims.

The present embodiment provides inventions at various stages thereof, and appropriate combinations of selected ones of the components of the embodiment provide various inventions.

What is claimed is:

1. An image pickup apparatus comprising:
an image pickup element, responsive to a periodically occurring drive timing signal, for picking up an image of an object;
a shutter key for producing an operation signal when depressed;
a main control unit for controlling the whole image pickup operation of the image pickup apparatus, for directly receiving the operation signal produced by operating the shutter key, and for sensing as an interrupt signal an initial change in the operation signal to thereby to give an instruction to cause the image pickup element to start to pick up the image of the object; and
an image processor, responsive to the instruction given by the main control unit, for immediately producing a drive timing signal to cause the image pickup element to start to pick up the image of the object without waiting for an occurrence of a periodically occurring drive timing signal, and for processing data on the image of the object picked up by the image pickup element.

2. The image pickup apparatus according to claim 1, further comprising:
a sub control unit for sampling a second operation signal, produced by depressing a key switch, at predetermined intervals of time to thereby produce a sampled signal, and for delivering information on the sampled signal to the main control unit.

3. The image pickup apparatus according to claim 1, further comprising:
a sub control unit for directly receiving a second operation signal produced by depressing a key switch, for sensing an on state of the received second operation signal, and delivering information on the sensed on state of the second operation signal to the main control unit.

4. The image pickup apparatus according to claim 1, wherein the main control unit determines that the shutter key is released when an off state of the operation signal was sensed successively a predetermined number of times by sampling the operation signal at predetermined intervals of time.

5. An image pickup apparatus comprising:
an image pickup element for picking up an image of an object;
a shutter key for producing an operation signal when depressed;
a main control unit for controlling the whole image pickup operation of the image pickup apparatus, for directly receiving the operation signal produced by operating the shutter key, and for sensing an on state of the operation signal to thereby give an instruction to cause the image pickup element to start to pick up the image of the object; and
a sub control unit for receiving a second operation signal produced by depressing a key switch, for sensing an on state of the second operation signal, and for delivering information on the sensed on state of the second operation signal to the main control unit.

6. The image pickup apparatus according to claim 5, wherein the main control unit senses as an interrupt signal an initial change in the operation signal produced by operating the shutter key and for giving an instruction to cause the image pickup element to start to pickup the image of the object.

7. The image pickup apparatus according to claim 5, wherein when the main control unit once senses an on state of the operation signal produced by operating the shutter key, by sampling the operation signal at predetermined intervals of time, the main control unit instructs the image pickup element to start pickup of the image of the object.

8. The image pickup apparatus according to claim 5, wherein the main control unit determines that the shutter key is released, when an off state of the operation signal was sensed successively a predetermined number of times by sampling the operation signal at predetermined intervals of time.

9. The image pickup apparatus according to claim 5, wherein:
the sub control unit samples a second operation signal, produced by depressing a key switch, at predetermined intervals of time to thereby produce a sampled signal, and for delivering information on the sampled signal to the main control unit.

10. The image pickup apparatus according to claim 5, further comprising:
an image processor, responsive to the instruction given by the main control unit, for producing a drive timing signal to cause the image pickup element to start to pick up the image of the object, and for processing data on the image of the object picked up by the image pickup element.

11. An image pickup apparatus comprising:
an image pickup element for picking up an image of an object;
a shutter key for producing an operation signal when depressed; and
a main control for directly receiving the operation signal produced by operating the shutter key, for sensing as an interrupt signal an initial change in the operation signal to thereby give an instruction to cause the image pickup element to start to pick up the image of the object, and for determining that the shutter key is released when an off state of the operation signal was sensed successively a predetermined number of times by sampling the operation signal at predetermined intervals of time.

12. The image pickup apparatus according to claim 11, further comprising:
a sub control unit for sampling a second operation signal, produced by depressing a key switch, at predetermined intervals of time to thereby produce a sampled signal, and for delivering information on the sampled signal to the main control unit.

13. The image pickup apparatus according to claim 11, further comprising:
a sub control unit for directly receiving a second operation signal produced by depressing a key switch, for sensing an on state of the received second operation signal, and delivering information on the sensed on state of the second operation signal to the main control unit.

14. The image pickup apparatus according to claim 11, further comprising:
an image processor, responsive to the instruction given by the main control unit, for producing a drive timing signal to cause the image pickup element to start to pick up the image of the object, and for processing data on the image of the object picked up by the image pickup element.

15. An image pickup apparatus comprising:
an image pickup element for picking up an image of an object;
a shutter key for producing an operation signal when depressed;
a main control unit for directly receiving the operation signal produced by operating the shutter key, for once sensing an on state of the operation signal by sampling the operation signal at predetermined intervals of time to thereby give an instruction to cause the image pickup element to start to pick up the image of the object, and for determining that the shutter key is released when an off state of the operation signal was sensed successively a predetermined number of times by sampling the operation signal at predetermined intervals of time.

16. The image pickup apparatus according to claim 15, further comprising:
a sub control unit for sampling a second operation signal, produced by depressing a key switch, at predetermined intervals of time to thereby produce a sampled signal, and for delivering information on the sampled signal to the main control unit.

17. The image pickup apparatus according to claim 15, further comprising:
a sub control unit for directly receiving a second operation signal produced by depressing a key switch, for sensing an on state of the received second operation signal, and delivering information on the sensed on state of the received second operation signal to the main control unit.

18. The image pickup apparatus according to claim 15, further comprising:
an image processor, responsive to the instruction given by the main control unit, for producing a drive timing signal to cause the image pickup element to start to pick up the image of the object, and for processing data on the image of the object picked up by the image pickup element.

19. An image pickup method comprising the steps of:
controlling the whole image pickup operation, directly receiving an operation signal produced by depression of a shutter key, and sensing as an interrupt signal an initial change in the operation signal to thereby give an instruction to cause the image pickup element to start to pick up an image of an object; and
responsive to the instruction, immediately producing a drive timing signal to cause the image pickup element to start to pick up the image of the object without waiting for an occurrence of a periodically occurring drive timing signal, and processing data on the image of the object picked up by the image pickup element.

20. An image pickup method comprising:
a main control step including controlling the whole image pickup operation, directly receiving an operation signal produced by depression of a shutter key, and sensing an on state of the operation signal to thereby instruct an image pickup element to start to pick up an image of an object; and
a sub control step including receiving a second operation signal produced by depression of a key switch, sensing an on state of the second operation signal, and delivering information on the sensed on state of the second operation signal to the main control step.

21. An image pickup method comprising the steps of:
directly receiving an operation signal produced by depression of a shutter key, sensing as an interrupt signal an initial change in the operation signal to thereby instruct an image pickup element to pick up an image of an object; and
determining that the shutter key is released when an off state of the operation signal was sensed successively a predetermined number of times by sampling the operation signal at predetermined intervals of time.

22. An image pickup method comprising the steps of:
directly receiving an operation signal produced by depression of a shutter key, sensing an on state of the operation signal by sampling the operation signal at predetermined intervals of time, and then instructing an image pickup element to start to pick up an image of an object when the on state of the operation signal was sensed once; and
determining that the shutter key is released when an off state of the operation signal was sensed successively a predetermined number of times by sampling the operation signal at predetermined intervals of time.
